(19) United States
(12) Patent Application Publication
(10) Pub. No.: US 2007/0267051 A1
(43) Pub. Date: Nov. 22, 2007

(54) Automated Cleaning System

(76) Inventor: Brent Gill, Beaverton, OR (US)

Correspondence Address: Greenberg & Lieberman, 2141 Wisconsin Ave N W, Suite C2, Washington, DC, 20007, US

(21) Appl. No.: 10/547,869

(22) PCT Filed: Sep. 29, 2003
(86) PCT No.: PCT/US03/30494

§ 371 Date: Aug. 21, 2006

Related U.S. Application Data
(60) Provisional application No. 60/414,430, filed on Sep. 27, 2002.

(51) Int. Cl. B08B 3/02

(52) U.S. Cl. 134/201

(57) ABSTRACT

The automated cleaning system is a device that cleans a clarifier without the use of harsh chemicals, brushes and scrappers. The automatic cleaning system uses the force of pressurized water to remove scum, algae and other sediment from the clarifier. The automated cleaning system can be designed to fit square, round, rectangle or dual chamber clarifiers. Various nozzles can be attached for the various cleaning needs for the specific clarifier.

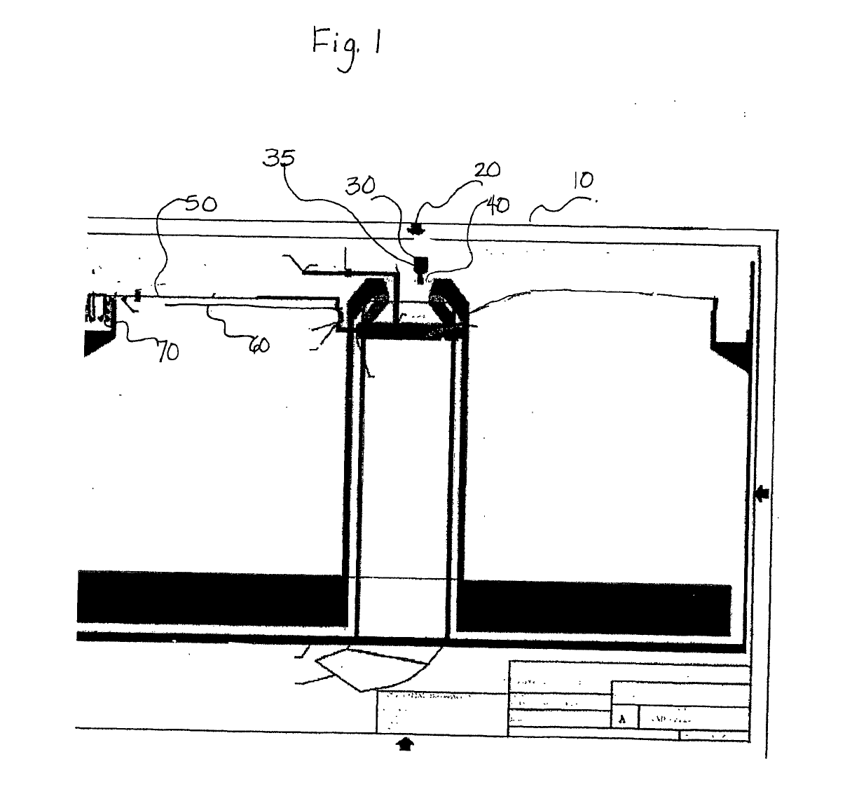

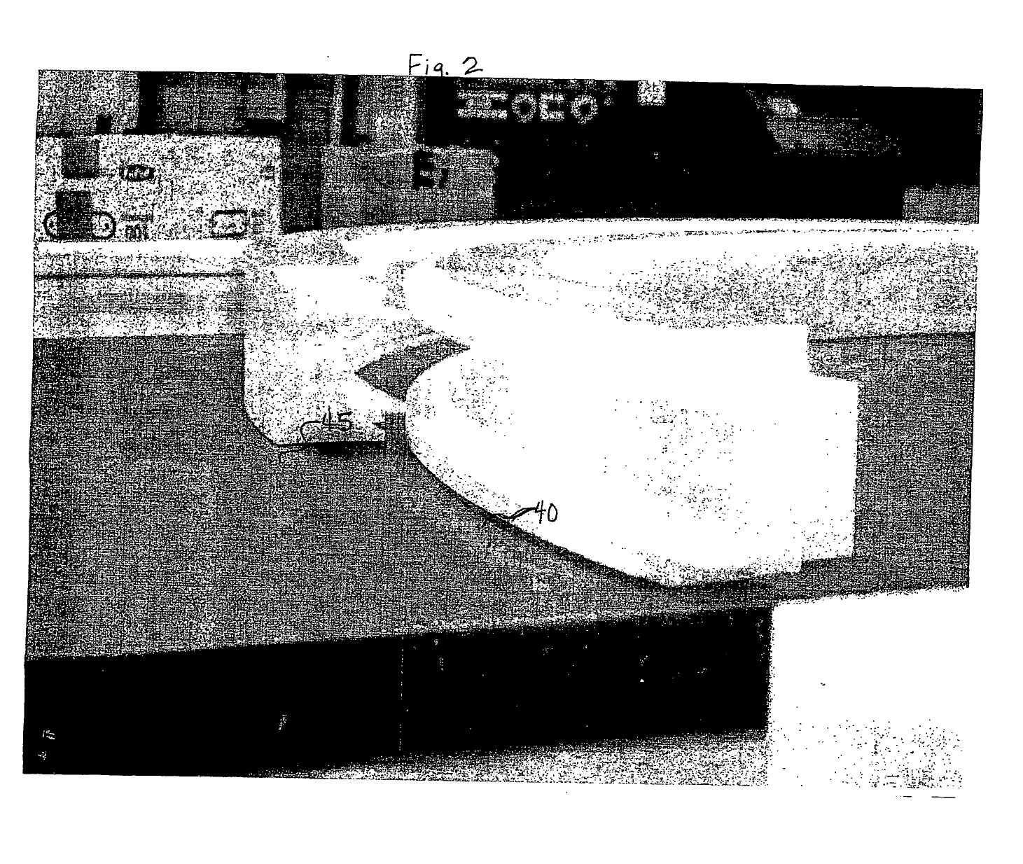

### FIELD OF THE INVENTION

The present invention relates to an automated cleaning system, and more particularly a cleaning system for a clarifier that uses pressurized water in the cleaning process.

### BACKGROUND OF THE INVENTION

In water treatment facilities water flows into settling tanks. Over time algae, scum and other particles settle in the weir. These particles are difficult to clean out of the weir. Other devices have been developed to clean weirs. Some of the inventions include the use of scrub brushes and harsh chemicals. The present invention is differs because it does not require harsh chemicals, scrapers and brushes. The present invention uses non-potable water and it uses the existing clarifier drive motor. The present invention relies on the pressure of the water and delivery to nozzle attachments to clean the weir more effectively than other devices. The present invention is different from other systems currently on the market that uses mechanical means of controlling the algae and foreign material. The present invention removes the algae and foreign materials instead of controlling it.

### DETAILED DESCRIPTION

The automated cleaning system uses the in plant service water by delivering the water to piping (60) attached to the center unit (35). The automated cleaning system is powered by the existing motor (30) that is installed on the clarifier (10). Water is supplied to piping (60) that runs under the walkway (50) out to the center column (25). The piping (60) carries the water into the area created between the inner stationary ring (40) and outer rotating ring (45). The outer rotating ring (45) is attached to a rotating spindle to rotate the outer rotating ring (45). The inner stationary ring (40) of the center unit (20) is attached to a secured mechanism so that it remains stationary. The water flows between the inner stationary ring (40) and the outer rotating (45) component of the center unit (35). The water is pressurized in this area. The piping (60) is then connected to the rotating component of the center unit (35). The clarifier drive is the motor (30) unit drives the center unit (35) with the rest of the rotating structure. The piping (60) is then routed along the scum arm or along the bottom structure of the rotating structure of the tank or clarifier. The piping (60) then is connected to the spray apparatus (70), which sprays the areas needing cleaning. The scum ring, weir, launder and outer wall are all area that can be cleaned. The center unit (35) during operation is designed to have a small amount of leakage. This leakage allows the center unit (35) to ride on a small water film between the stationary and rotating components of the center unit (35) minimizing the horsepower necessary to rotate the rotating component of the center unit (35).

Depending on the shape of the clarifier (10) that needs to be cleaned, various apparatus can be attached to the nozzle, including a spray nozzle (70) or an articulated spray nozzle.

The various nozzles are positioned and angled at varying degrees to aim directly to comers in the clarifier. Many clarifiers have obstructions mounted on the weirs or in other areas that prevent the spray nozzles (70) from functioning. This requires the spray apparatus to fold or retract from the cleaning area while it passes the obstructions and then automatically returns to the required cleaning position. The spray apparatus oscillates back and forward over the targeted cleaning area. The present invention can be designed to fit round, square, dual chamber, rectangular, and other shaped clarifiers.

I claim:

1. A device for cleaning a clarifier, comprising;
a water supply;
an inner ring, in communication with said water supply;
an outer ring circumscribing said inner ring;
said inner ring;
receiving said water supply;
a means for delivering said water supply from said outer ring to the clarifier.
